(19) United States
(12) Patent Application Publication
(10) Pub. No.: US 2014/0172819 A1
(43) Pub. Date: Jun. 19, 2014

(54) HUMAN ASSOCIATION SEARCH ENGINE

(71) Applicants: Niva Bar-Shimon, Atlit (IL); Yoram Yarkoni, Haifa (IL)

(72) Inventors: Niva Bar-Shimon, Atlit (IL); Yoram Yarkoni, Haifa (IL)

(21) Appl. No.: 14/236,076

(22) PCT Filed: Jul. 31, 2012
(86) PCT No.: PCT/IB2012/053907

§ 371 Date: Jan. 30, 2014

Related U.S. Application Data
(60) Provisional application No. 61/513,596, filed on Jul. 31, 2011.

(51) Int. Cl. G06F 17/30

(52) U.S. Cl. CPC G06F 17/30864
USPC 707/706

(57) ABSTRACT

A method, computer system and computer-readable instructions for collecting and displaying associated items including: (a) presenting at least one Trigger Association Item to Uploading Users; (b) receiving Association Chains of Association Items from at least a portion of the Uploading Users in response to the presented Trigger Association Item, and (c) storing the Association Chains in an Association Database.

### FIELD AND BACKGROUND OF THE INVENTION

The present invention relates to a search engine and, more particularly, to a search engine that is specifically configured to gather, organize and search associations of human origin, whether text, audio or visual.

A known procedure for forming associations is to do brain storming and play the association chain game. Today advertising agencies look for effective ways to measure relations between attitude and behavior. The belief of a client of the ad agency that the agency knows and understands the target audience and what it does, is not definite.

Agencies test ideas on focus groups and in this manner try to refine the best version of the advertisement to the audience the agency believe is the most appropriate.

There is a long felt need to have a tool that would enhance creative and strategic abilities during the work process at an advertising agency by being able to ‘tap into the minds’ of an audience and access new and original ideas that would improve the efficiency of the work process in such environments.

It would be highly advantageous to have a tool for gathering associations (whether textual, audio and/or visual) that are made by human beings and arranging the associations in a manner that can be used in advertising campaigns and the like.

### DEFINITIONS

The term ‘Association Item’ refers to an idea, concept, word or piece of data in some media format (textual, audio or visual).

The term ‘Association(s)’ refers to a subjective word, idea, concept or piece of data in some media format (textual, audio or visual) that comes to mind when referring to a specific Association Item. Generally speaking, the terms Association and Association Item can be used interchangeably.

An ‘Association Chain’ refers to ‘daisy-chain’ set of associations, where each association link in the chain is associated with the previous association link in the chain. For example, the Association Item ‘spy’ brings to mind the association ‘Bond’, which in turn brings to mind ‘convertible’ which brings to mind the association ‘girl’. Furthermore, the association item ‘spy’ brings to mind a number of other associations, each having at least one chain of their own. FIG. 2 is a screenshot that depicts one potential embodiment of an association chain which has been navigated from the word ‘Jewish’ which is associated with the word ‘Bank’.

A Trigger Association Item is an Association Item which may or may not have a chain of associations related thereto. Trigger Association Items are used as an association “trigger” for Uploading Users to supply freely associated items in response to the “trigger”. Any Association Item can be used as a Trigger Association Item. The Trigger Association Item is at the head of an association chain.

### SUMMARY OF THE INVENTION

The present invention discloses an innovative system which enables a user to search a pool (database) of associations, which are uploaded to the system by users. The core database includes association items, associations to the association items and association chains. The database is intrinsically dynamic, constantly growing. The Associations are different types of media, including: text, image, video, sound and link. One main application of the system is for creative thinking Creative thinking is a useful and sometimes necessary tool in a variety of fields, including but not limited to, advertising, management, research, education and more.

The system has a variety of users. Uploading Users supply/upload free associations into the system. The uploading process is preferably spontaneous, and represents, as accurately as possible, the “real” associative inner world of the user (i.e. the real associations that occurs to the user when presented with an audio or visual trigger). The system not only retains and saves the associations themselves but also data about the users who uploaded the associations (characteristics such as: location, age, gender, profession, interests and so on), and about the process of uploading the associations (the time in which the association was uploaded, the duration of the uploading process, and so on). The experience of uploading is preferably accompanied by a strong motivation, but preferably not of the financial type (e.g. gaming or social interaction).

At least two types of End Users are envisioned: creative and strategic. Of course many other types of users may find interest in the system, especially as the database and system grows and develops (just as Google™ is more than just a search engine).

Creative end users of the system, generally come from the field of design and advertising. These users search and navigate between associations from the pool, and use the system as a creative work tool. In some embodiments the End User Interface for creative users is flexible, either linear or spatial (3D).

Strategic end users of the system, generally come from the field of planning, market strategy and research. These users use the system for data mining and analysis of data collected in the system database. E.g. marketers who spot an association trend in a particular age range are able to direct the marketing campaign to focus on the age range detected by the Association Tool of the immediate invention.

According to the present invention there is provided a computerized system including: an Association Database including: Trigger Association Items and Association Chains, each of the Association Chains including at least one Association Item in addition to a respective Trigger Association Item; a computer-readable non-transient memory, wherein are stored instructions that include: (a) program code for a downloadable Association Collection Application (ACA); (b) program code for an Association Logic module for managing the Trigger Association Items and the Association Chains of the Association Database; and a processor, for executing the program code.

According to further features in preferred embodiments of the invention described below the instructions further include: (c) program code for an End User Interface (EUI), for interfacing between the computerized system and End Users.

According to still further features in the described preferred embodiments the EUI interacts with the Association Logic module so as to provide a Search function, for selecting Association Chains according to instructions received from the End Users via the EUI.

According to still further features the selected Association Chains are presented to the End Users via the EUI as search results.

According to still further features the search results are presented via the EUI in a visualization format selected from the group including: a spatial format, and a linear format.

According to still further features the instructions further include: (d) program code for a set of Filters, for filtering the search results.

According to still further features the instructions further include: (d) program code for a Search Cart, for electively storing a portion of Association Items included is the Association Chains of the search results.

According to still further features the Search function selects the Association Chains having a format selected from the group including: a text format, an image format, an audio format, a visual format, and a combination of any of the above.

According to still further features the instructions further include: (d) program code for an Artificial Intelligence (AI) mechanism, for learning patterns according to which the End Users use the Search function.

According to still further features the downloadable ACA is adapted to present at least one Trigger Association Item selected from the Association Database to Uploading Users, and further adapted to receive, from a portion of the Uploading Users, at least one Association Chain related to the at least one Trigger Association Item.

According to still further features each received Association Chain is stored in the Association Database.

According to still further features the system further includes a Data-Mining Database for storing user information of the Uploading Users.

According to still further features the instructions further include: (c) program code for an End User Interface (EUI), for interfacing between the computerized system and End Users, wherein the EUI interacts with the Data-Mining Database so as to provide a Report function, for organizing the user information according to instructions received by the End Users via the EUI.

According to still further features the organized user information is presented to the End Users via the EUI as reports.

According to still further features the program code for the downloadable ACA further includes: (i) program code for a Website Application, for downloading instances of the Website application for embedding into website pages, (ii) program code for a Mobile Application, for downloading instances of the mobile application for installation in mobile devices, and (iii) program code for a Personal Computer (PC) Application, for downloading instances of the PC application for installation in PC devices.

According to still further features the instructions further include: (c) program code for an External Application Interface, for interfacing between external applications and the computerized system.

According to another embodiment, there is provided a computing system for an association platform, including: (a) at least one networked server; (b) an Association Database, associated with the at least one networked server, for storing Trigger Association Items and Association Chains, each of the Association Chains including at least one additional Association Item in addition to a respective Trigger Association Item; and (c) a client computer-readable instruction set, associated with the at least one networked server and downloadable by a user, wherein the instruction set is configured to present at least one Trigger Association Item selected from the Association Database to Uploading Users, and further configured to receive, from at least a portion of the Uploading Users, at least one Association Chain related to the at least one Trigger Association Item.

According to still further features the system further includes: (d) an End User Interface (EUI), for interfacing between the computer system and End Users.

According to another embodiment there is provided a method for collecting and displaying associated items, the method including the steps: (a) presenting at least one Trigger Association Item to Uploading Users; (b) receiving Association Chains from at least a portion of the Uploading Users in response to the presented at least one Trigger Association Item, each Association Chain including at least one Association Item; and (c) storing the Association Chains in an Association Database.

According to still further features the method further includes the steps of: (d) providing an End User Interface (EUI), for interfacing between the Association Database and an End User.

According to still further features the storing includes a recognition process including steps of: (i) checking each unique Association Item, in the Association Chains, for lingual proximity to a stored Association Item; (ii) correcting each unique Association Item having lingual proximity to a stored Association Item; and (iii) counting instances of each Association Item.

According to still further features the method further includes the steps of: (d) receiving a search query at the Association Database; and (e) presenting search results selected from the Association Database, the search results including at least one Association Chain being responsive to the search query.

According to still further features the method further includes the steps of: (f) learning patterns in which the search queries are received and in which the search result are selected so as to provide enhanced searching features.

According to still further features the method further includes the steps of: (d) collecting user information regarding the Uploading Users.

According to still further features the method further includes the steps of: (e) receiving a report request for the user information; and (f) presenting report responsive to the report request.

According to still further features the Trigger Association Item includes an Association Item selected from the Association Database.

The present invention successfully addresses the shortcomings of the presently known methods and tools used for advertising campaigns. A commonly used tool is an Attitude Survey. Today the most common test to detect the best incentives or correct audience is an attitude survey. The immediate innovation is preferable over the current methods as associations are an implicit reaction on a subject whereas attitude surveys only provide an explicit opinion. When advertising, it is the implicit feeling which is more important. For example—a survey concerning approaching a doctor about an embarrassing medical problem, that might show biased results. Because free associations are less conscious than attitudes (implicit), they intend to reflect a more genuine approach to certain issues.

The product of the immediate innovation presents advanced tools for advertising agencies and Brand owners. Some exemplary advanced features include: Means to measure ongoing campaigns, predicting success of campaigns, measure brands across time, measure brands by age, location and other characteristics and segmentations.

The premise is that associations give a precise picture about what potential customers really think about a product or campaign or subject. This knowledge can help the advertising agencies and brands to understand client perceptions in a much better manner.

The present invention discloses an innovative tool for collecting associations from people online and organizing the information to present a precise picture of how a Brand is perceived and how best to advance a possible advertising campaign.

### BRIEF DESCRIPTION OF THE DRAWINGS

Various embodiments are herein described, by way of example only, with reference to the accompanying drawings, wherein:

FIG. 1 is a schematic block-drawing of a preferred embodiment of the hardware/software architecture of the innovative Association Search Engine;

FIG. 2 is a screenshot that depicts one potential embodiment of an association chain;

FIG. 3 is a screenshot of a search result filtered by media;

FIG. 4 is a screenshot of a search result filtered by age;

FIG. 5 is a screenshot depicting a communal activity;

FIG. 6 is a screenshot of a potential embodiment of a linear representation of associations;

FIG. 7 is a screenshot of a potential embodiment of a spatial (3D) representation of associations;

FIGS. 8a and 8b are screenshots of an exemplary manner of interfacing with a 3^{rd} party application;

FIG. 9 is a flow diagram of an embodiment of the basic flow of the innovative system.

### DESCRIPTION OF THE PREFERRED EMBODIMENTS

The principles and operation of a human association search engine according to the present invention may be better understood with reference to the drawings and the accompanying description.

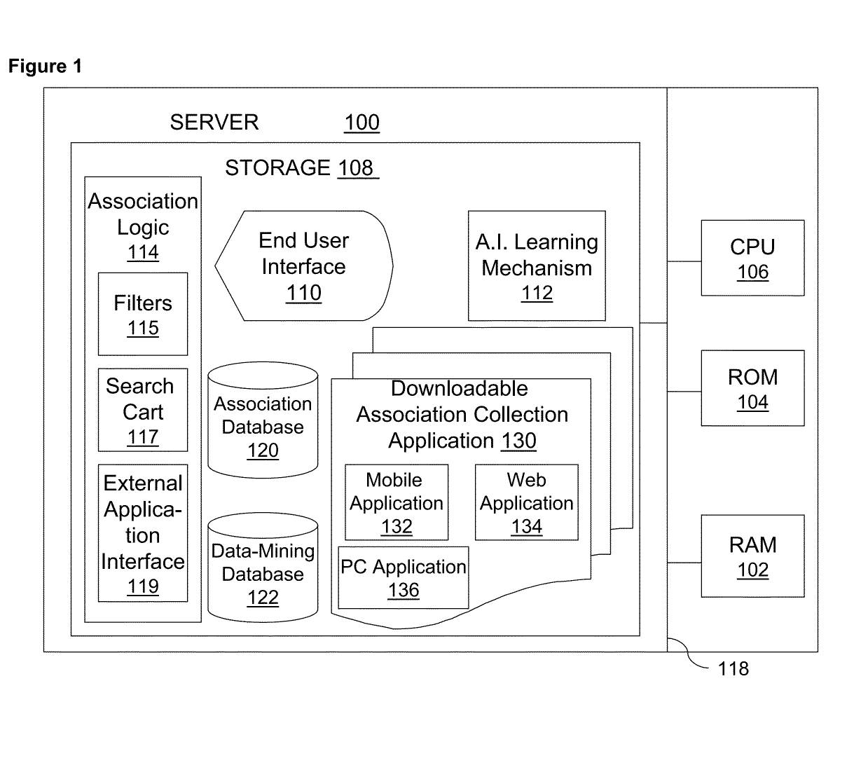

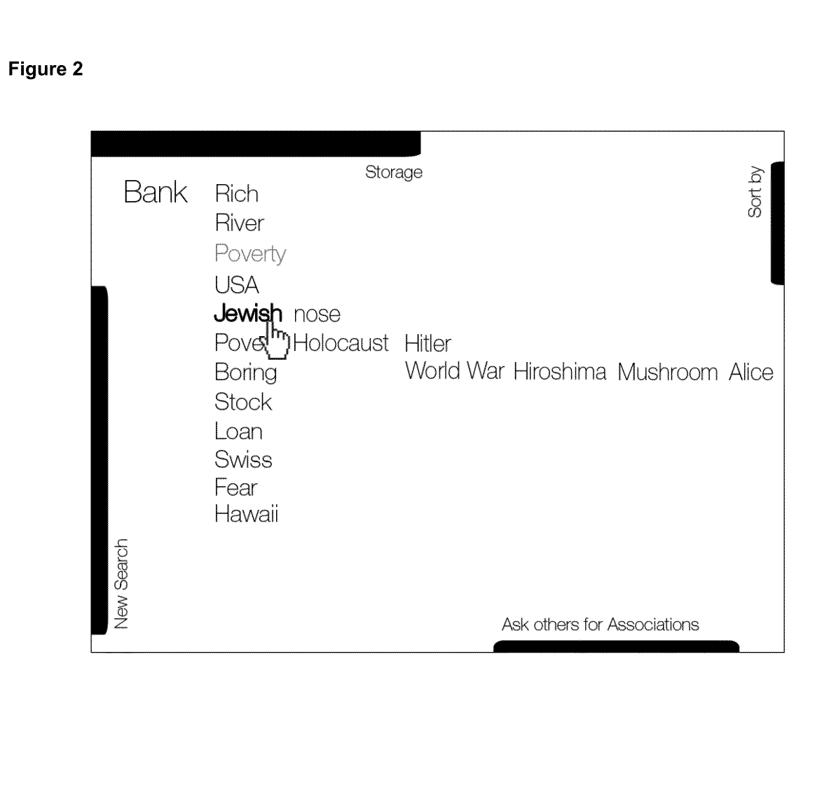

Referring now to the drawings, FIG. 1 illustrates a schematic block-drawing of a preferred embodiment of the hardware/software architecture of the innovative Association Search Engine of the immediate invention.

Server 100 includes a RAM 102, a ROM 104, a CPU 106 (or any other processor), a non-volatile storage unit 108 and a bus 118 connecting all the components to each other. It is clear that the high-level block diagram is only a partial representation of a server. Furthermore, each of the components depicted within server 100 are not intended to be limiting but rather representative of an exemplary embodiment. Some or all of the components depicted in storage unit 108 may alternatively reside in one or more additional servers which may or may not be collocated. An End User Interface 110 presents a visualization of association items and chains of associations in either a linear, spatial (3D) or other representation. An Artificial Intelligence (AI) mechanism 112, included in some embodiments of the invention, learns search patterns of users, detects association trends and identifies needs for more accurate collection methods, and improvements of the search algorithm (see “target ticker” below). AI mechanism 112 can provide enhanced searching features which take into account the learned search patterns and/or detected association trends and/or other needed improvements identified by AI 112. An Association Logic module 114 includes the software/algorithms which drive the search engine, including, but not limited to, association logic, filters 115, report generators, search cart 117 and so on. Association Items are stored in a related—or big data—Association Database 120 which includes the associations and association chains between the items. A Data-Mining Database 122 stores all the user information relating to associations and searches for the associations. A downloadable Association Collection Application 130 resides on Server 100 and instances of the software package can be downloaded in various formats: a Web(site) Application 134 can be embedded in websites (e.g. as a FaceBook™ game); a Mobile Application 132 can be downloaded to mobile devices such as smartphones and tablets in the form of ‘apps’ or ‘widgets’ or any other type of mobile format; and lastly, a PC Application 136 version of the software package 130 can be downloaded to a client computer such as a desktop or laptop computer.

Some of the main capabilities and features of the system are enumerated below:

Collection and Storage

The system collects and stores free associations received from Uploading Users, by presenting a stimulus/trigger which is generally selected from the association pool or according to customer needs. The collection is performed throughout the Internet by flexible and dynamic means, such as, but not limited to: games, social activities, quizzes, viral activities and so on. The software modules for these online means are stored on Server 100 and instances thereof can be downloaded and embedded/installed as mentioned above. Uploading Users are users that play the games or partake in the quizzes, social and viral activities and so on. The aforementioned dynamic means may explicitly publicize that the users' input is being used to improve Association Database 120 or not. The latter state may be preferable from a psychological stand point. On the other hand consent to make use of user input must be received where consent is required by law or accepted practice. During collection into Association Database 120, the system recognizes items that already exist in the pool and registers for frequency (e.g. keeps a counter of the number of instances that each unique Association Item appears). The system also recognizes errors and lingual proximity of items and automatically corrects the spelling (or suggests correction), deciding whether to create a new item or change frequency of an existing item. For example, ‘reciepf would be corrected to ‘receipt’ whereas ‘cheque’ (British spelling for a bank check) would be recognized as the same item as a ‘check’. The database contains the relationships between associations and data from the uploading process and about the uploading users.

Association Search

Search of associations through the association database. In some embodiments, the search is textual, whereas in other embodiments the search is additionally or alternatively based on audio and/or visual. In still other embodiments, the search engine additionally contains AI (Artificial Intelligence) elements 112 which learn the search patterns of users. For example—the search engine can present enhanced searching features to a user who has performed several searches which were previously performed by another user with a result that the previous user reached eventually.

Filtering Search Results

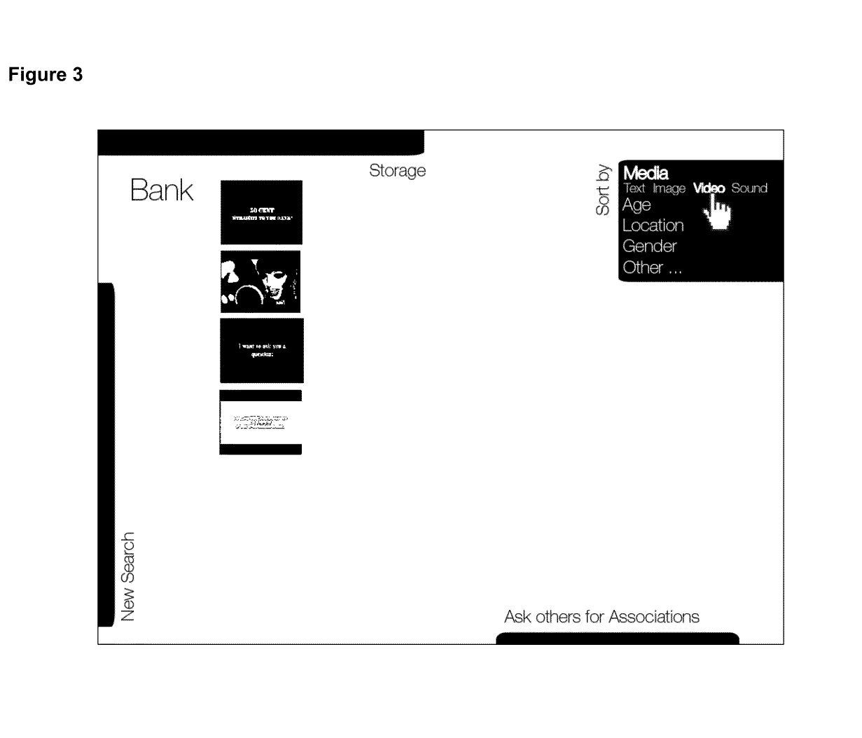

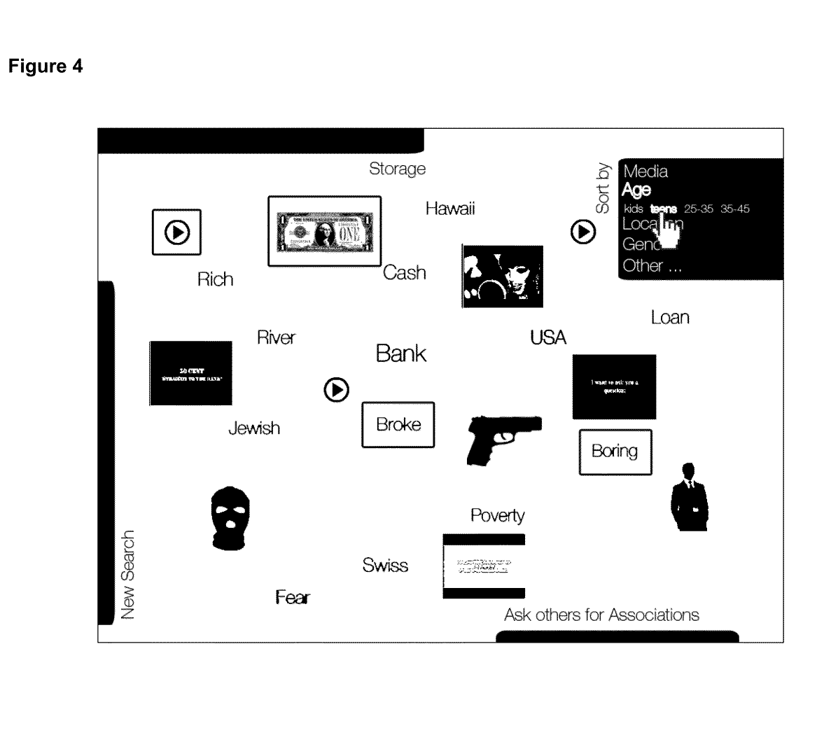

The system can organize search results using filters. The filters may organize results according to media, statistic data about the associations, commonality, or even by segmentation according to the uploading-user data. In one exemplary embodiment, the filtering function removes results (association items) from the search results or, in another exemplary embodiment the system shades filtered items. One potential embodiment of a search result for the word ‘Bank’ filtered by ‘media’ is depicted in FIG. 3. FIG. 3 is a screenshot of a search result filtered by media. In this case the media is video. FIG. 4 is a screenshot of a further exemplary search result for the word “Bank”, which has been filtered by age of the Uploading Users. The filter in FIG. 4 is “teens” where the results selected by teenagers are boxed.

‘Search Cart’

The system enables the user to add and save items of interest, during the search process, into a personal storage feature in the system. In some embodiments of the system, an End User has an account on the online Search Engine/System of the immediate invention. Once the account is accessed then a personal Search Cart saves the selected associations as requested by the end user. In embodiments which do not offer an account login feature, or for user without an account, the system provides a Search Cart feature for the duration of the session. When exiting, the system offers to save the contents of the Search Cart to a local storage facility (e.g. hard drive of the PC).

Data-Mining Datbase

In some embodiments of the invention, the system includes Data-Mining Database 122. Data-Mining Database 122 stores all data gathered from Uploading Users during the process of interacting with ACA 130 (and/or the various downloaded/embedded/installed instances of the ACA 130). The data includes user information as well as information regarding the uploading process.

Reports

Queries about specific associations found in the pool result in reports and analysis of data about the associations and the uploading users. For example: the frequencies of different associations to a specific association item, the percentage of users who associated one item with another specific item, the length of chain of associations between two items or more, the percentage of users with a specific personal characteristic who associated two items to one another, how many different chains of associations exist between two specific items, and so on. Generally, the information for the reports is drawn from Data-Mining Database 122. This activity can be restricted to authorized users only.

Visualization

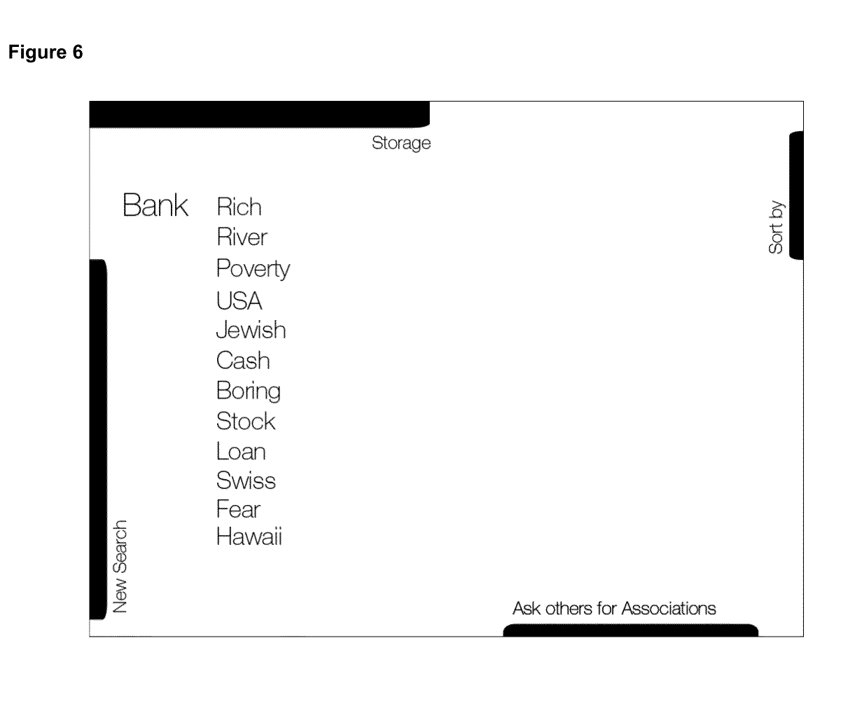

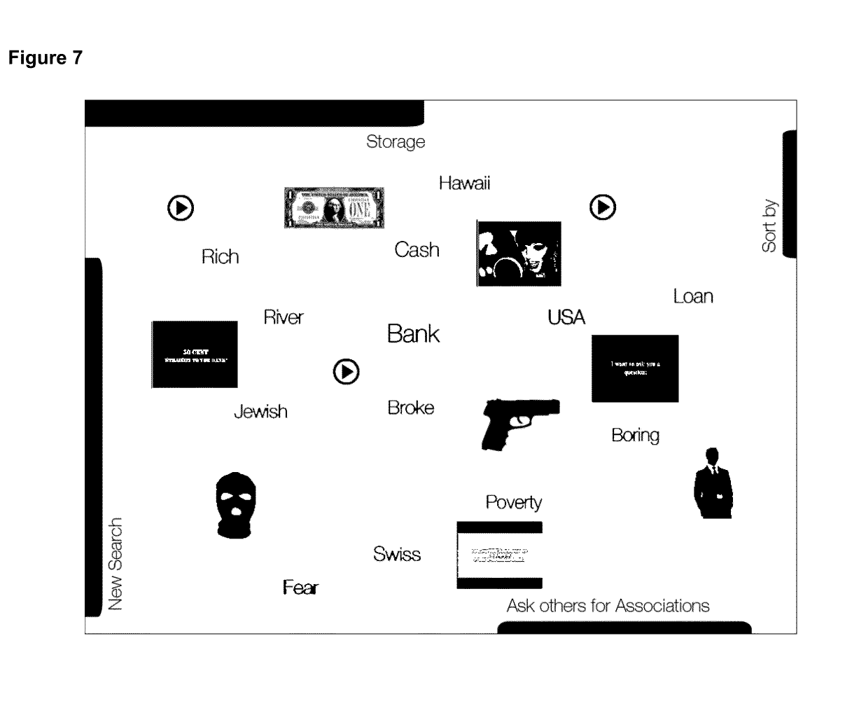

The visualization of association items and chains of associations in End User Interface (EUI) 110 reflects the structure of the pool. The EUI enables users to select the type of visualization they prefer: linear or spatial representations are two exemplary visualization modes. FIG. 6 is a screenshot of a potential embodiment of a linear representation of associations. FIG. 7 is a screenshot of a potential embodiment of a spatial (3D) representation of associations.

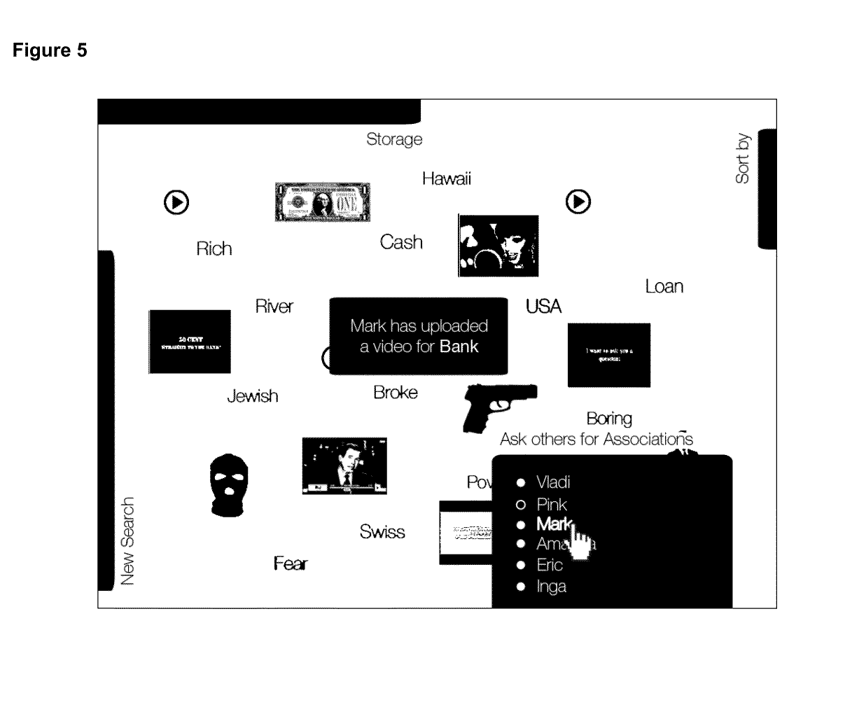

The system can potentially have a great influence on social interaction over the Internet. End Users can choose individual or communal activities, with the system enabling and supporting online communication between users participating in communal activities. Users are able to ask their online collaborators to provide associations to specific items (possibly taken from the database, or a new item, not found in the database). To enable collaboration, the system enables a user to build a user profile (which can, potentially, be imported from other social networks). The profile itself also supplies statistical information to the system regarding the uploaded associations from those registered/profiled users as well as information relating to user activity. The system furthermore supports multi-lingual activity, thereby better facilitating wider social and communal activity within the system. An exemplary communal activity is depicted in FIG. 5. FIG. 5 is a screenshot depicting a communal activity. In the image, a user going by the name “Mark” receives a request for associations for the word “Bank” and uploads a video. The indication for the activity appears in the middle of the screen.

Potentially, the system stores profile information, including personal details regarding the characteristics of the users (primarily Uploading Users, but in some embodiments, anonymous personal information of End Users may also be recorded), while protecting the privacy of the users. The profile information, in general, is used for statistical purposes. To this end, a user is merely identified by a number or designation, as opposed to name and address (or other identifying information, such as ID number, credit card number, etc.).

Interfacing with External Internet Applications

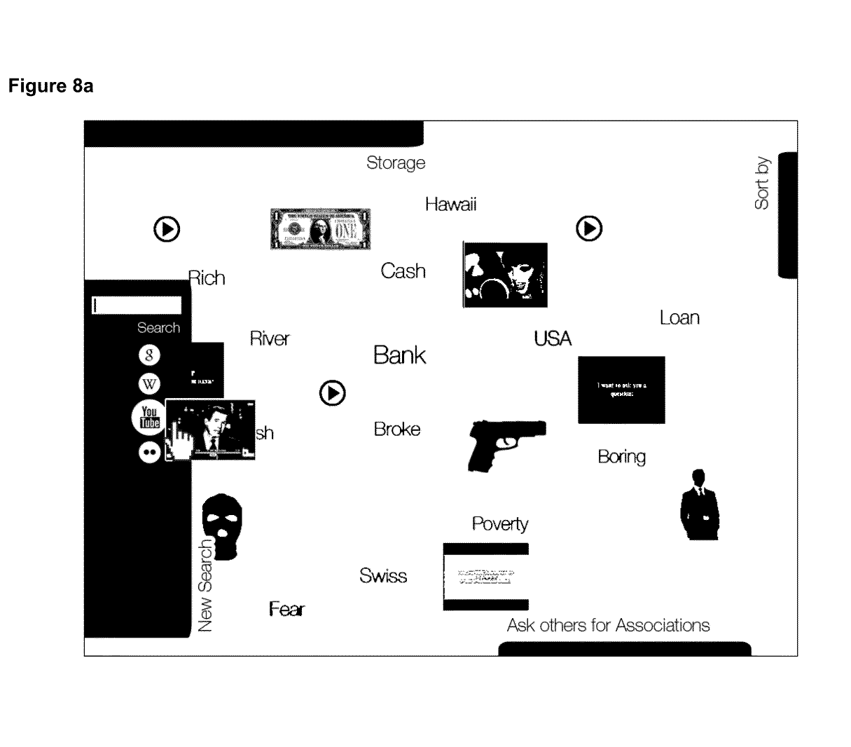

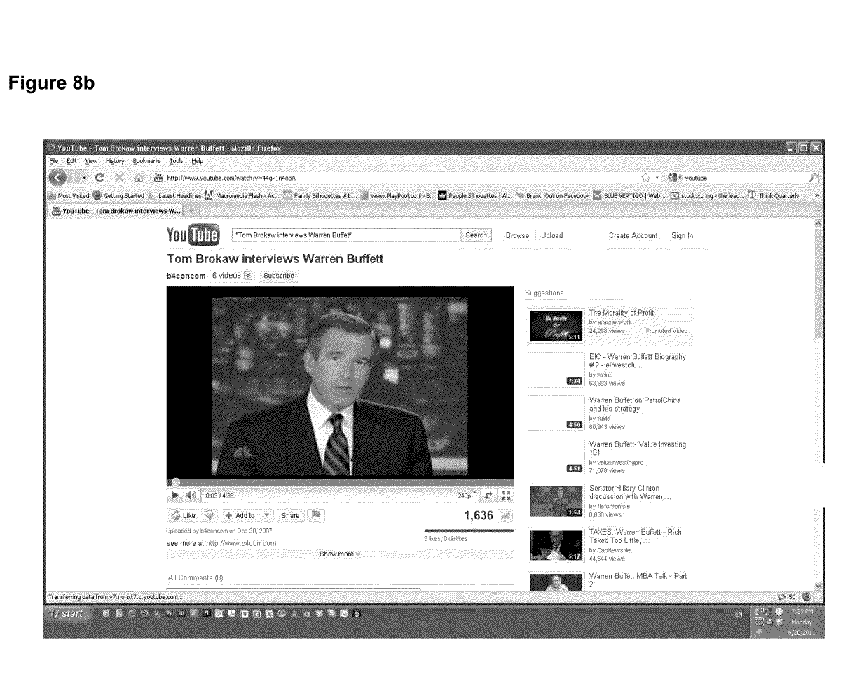

The system allows, enables and encourages end users to interface with external applications such as Google™, Wikipedia™, dictionaries, YouTube™, Flickr™ and more, in order to collect additional information about each association item in the pool. An External Application Interface 119, part of Association Logic 114 (FIG. 1), provides an interface between such external applications and the system of the immediate invention. Furthermore, the associations may be uploaded directly from the external applications. FIGS. 8a and 8b depict screenshots of an exemplary manner of interfacing with a 3^{rd} party application. In FIG. 8a, a video association item is dragged into the YouTube™ icon on the search menu, at the left of the screen (expanded from previously collapsed state). This action results in opening the video on YouTube198 , which is the place of origin of the item, as is depicted in FIG. 8b.

Some potential envisioned applications are enumerated below.

The system can provide a basis for a search algorithm that uses associations (as opposed to keywords) for better search results through the World Wide Web. The system will be integral to the creation of a global communal language (meta-language) that provides better associative global communication between people. The system provides the basis for the creation of a decision-making mechanism based on associations. The database serves as a basis for the creation of an Association Dictionary for research purposes, which maps relationships between concepts and ideas.

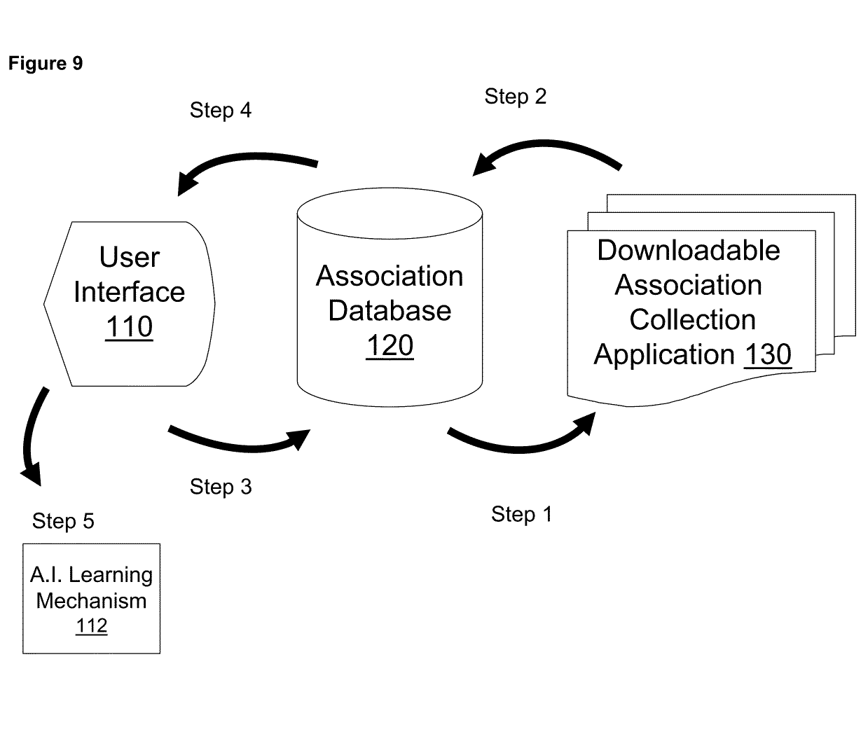

FIG. 9 is a flow diagram representing an embodiment of the basic flow of the innovative system. Association Database 120 is a central feature of the system. The database/association pool contains the associations, links between associations and characteristics of uploading users.

Step 1: Association Items drawn from Association Database 120 serve as stimuli for Association Collecting Application (ACA) 130. ACA 130 collects association items (and relationships between the items) from Uploading Users. At the same time ACA 130 also collects information regarding the Uploading Users (e.g. age, profession, interests, social demographics etc.) as well as information relating to the uploading process (e.g. response time and duration of interaction with the application). In some embodiments of the invention, this user information is stored in Data-Mining Database 122 as discussed above. The applications are downloaded from the server and embedded in social media networks such as FaceBook™ and Twitter™. Mobile applications as well as PC application are also envisioned as discussed above. The applications may be generic, all purpose Item collectors or may be tailor made/configured, to seek association information regarding a particular item, concept or area of interest.

Step 2: The association information is uploaded from ACA 130 to Association Database 130. The uploaded information is assimilated into Database 120.

Step 3: The end user is presented with End User Interface 110, which can be generic for all end-users, or specifically created/configured for particular clients. End-users generally have the choice between a linear and spatial (3D) visualization of search results. End users interact with Association Database by sending search queries and fetch requests.

Step 4: Association Database 120 responds to search queries and fetch requests submitted by end users via EUI 110 by present search results. In this manner, end users can navigate through the association pool, search for items in the pool, create or apply filters to search results and supply queries to the database and receive reports in response.

Step 5: In some embodiments, all the information about the user searches is gathered for AI learning mechanism 112 to grow and develop.

Additional Applications—Client Software—Concept Board

A further feature of the innovative system dubbed a “Concept Board” which provides a multi-functional unique planning and research tool for advertising companies, brand and marketing managers, academic institutions and so on, with an insight into the all important question “what people think?”.

The Concept Board makes use of the three major components of the system, namely: Association Collection Application (ACA) 130 (sometimes referred to as an ‘Association feeder’); Association Database 120; and End User Interface 110 (which may additionally or alternatively be downloadable Client Software) for fetching and analyzing information. The Concept Board accompanies the common process of planning and creating an advertising campaign in an advertising agency, starting with planning, strategy, creative concept and design, and following the campaign results.

The concept board presents the output and the final view of associations from Associations Database 120 which are acquired using ACA 130 in order to understand people and market incentives. The appearance, data interpretations, filters and trends are the most significant parameters which define the system.

End User Interface

The interface strives to be familiar so as not to require the user to learn a new interface. Concept Board provides a range of features and tools for the step-by-step process of creating and managing a advertising campaign or creative project. The questions of: “Who is your audience?”, “How do they think?”, “What relates with what?” and so on can be addressed via the various tools and features of the immediate system.

Example: Concept Board Functionality Units

| Function | Explanation |
|---|---|
| Create | Create a new campaign that logs any information gathered |
| campaign | relating to the campaign. |
| Test | Input the keywords that define a client and client brandin |
| research | order find out who the client audience is, what other fields of |
| | interests the audience has and what the main keywords link |
| | to. |
| Commit | Enter keywords to begin process. Explore the pool of |
| a search | associations presented. Filter the results by age groups, |
| | regions, strength of connections between the links, trend of |
| | changes over logged time etc. |
| Output | Import the most important data found into graphical tools for |
| a search | preparing user-friendly reports. |
| Alert | Create alerts for keywords and/or links to notify the user |
| | regarding how the audience is affected by different |
| | campaigns, competitors or just over time. |

Defining the search is critical, although keywords can always be changed.

An exemplary list of main filters includes, but is not limited to: User Localization, User Age groups, Association Strength (i.e. only strong connections), Association Trend (i.e. connections with declining trend over time), Association Linkage (i.e. connecting with less links), User Social status (Married, single, in a relationship), User Profession and User Interests.

Association Collection Algorithm

In one embodiment, Association Database 120 is a data base of associations, which are simply words or expressions connected to each other. Initially, Association Database 120 only includes a basic vocabulary of words for use as target words. These words are used as triggers for ACA 130. As it is preferable to have the most interesting phrases (to the client) presented as target words in order to receive the most valuable association information that can be used when creating a campaign or research project. Understanding which words and phrases are interesting, what is in demand and how the audience reacts to the choice of target words is the job of a module dubbed “Target Picker”.

In one embodiment, a simple algorithm is used to select target words. The algorithm takes into consideration the frequency of inputs, vocabulary which is prevalent for each word and additional parameters. In other embodiments, Target Picker is employed. Target Picker is based on an engine that helps the system decide which target word is the most suitable for each searcher.

Trend Detection

The system structures data in a manner that allows for measuring trends by splitting the data to fragments and reviewing changes between each fragment.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A computerized system comprising:
an Association Database including: Trigger Association Items and Association Chains, each of said Association Chains including at least one Association Item in addition to a respective said Trigger Association Item;
a computer-readable non-transient memory, wherein are stored instructions that include:
(a) program code for a downloadable Association Collection Application (ACA); and
(b) program code for an Association Logic module for managing said Trigger Association Items and said Association Chains of the Association Database; and
a processor, for executing said program code.

2. The computerized system of claim 1, wherein said instructions further include:
(c) program code for an End User Interface (EUI), for interfacing between the computerized system and End Users.

3. The computerized system of claim 2, wherein said EUI interacts with said Association Logic module so as to provide a Search function, for selecting Association Chains according to instructions received from said End Users via said EUI.

4. The computerized system of claim 3, wherein said selected Association Chains are presented to said End Users via said EUI as search results.

5. The computerized system of claim 4, wherein said search results are presented via said EUI in a visualization format selected from the group including: a spatial format, and a linear format.

6. The computerized system of claim 4, wherein said instructions further include:
(d) program code for a set of Filters, for filtering said search results.

7. The computerized system of claim 4, wherein said instructions further include:
(d) program code for a Search Cart, for electively storing a portion of Association Items included is said Association Chains of said search results.

8. The computerized system of claim 3, wherein said Search function selects said Association Chains having a format selected from the group including: a text format, an image format, an audio format, a visual format, and a combination of any of the above.

9. The computerized system of claim 3, wherein said instructions further include:
(d) program code for an Artificial Intelligence (AI) mechanism, for learning patterns according to which said End Users use said Search function.

10. The computerized system of claim 1, wherein said downloadable ACA is adapted to present at least one said Trigger Association Item selected from the Association Database to Uploading Users, and further adapted to receive, from a portion of said Uploading Users, at least one said Association Chain related to said at least one Trigger Association Item.

11. The computerized system of claim 10, wherein each said received Association Chain is stored in the Association Database.

12. The computerized system of claim 10, further comprising a Data-Mining Database for storing user information of said Uploading Users.

13. The computerized system of claim 12, wherein said instructions further include:
(c) program code for an End User Interface (EUI), for interfacing between the computerized system and End Users,
wherein said EUI interacts with said Data-Mining Database so as to provide a Report function, for organizing said user information according to instructions received by said End Users via said EUI.

14. The computerized system of claim 13, wherein said organized user information is presented to said End Users via said EUI as reports.

15. The computerized system of claim 1, wherein said program code for said downloadable ACA further includes:
(i) program code for a Website Application, for downloading instances of said Website application for embedding into website pages,
(ii) program code for a Mobile Application, for downloading instances of said mobile application for installation in mobile devices, and
(iii) program code for a Personal Computer (PC) Application, for downloading instances of said PC application for installation in PC devices.

16. The computerized system of claim 1, wherein said instructions further include:
(c) program code for an External Application Interface, for interfacing between external applications and the computerized system.

17. A computing system for an association platform, comprising:
(a) at least one networked server;
(b) an Association Database, associated with said at least one networked server, for storing Trigger Association Items and Association Chains, each of said Association Chains including at least one additional Association Item in addition to a respective said Trigger Association Item; and
(c) a client computer-readable instruction set, associated with said at least one networked server and downloadable by a user,
wherein said instruction set is configured to present at least one Trigger Association Item selected from said Association Database to Uploading Users,
and further configured to receive, from at least a portion of said Uploading Users, at least one said Association Chain related to said at least one Trigger Association Item.

18. The computer system of claim 17, further comprising:
(d) an End User Interface (EUI), for interfacing between the computer system and End Users.

19. A method for collecting and displaying associated items, the method comprising the steps:
(a) presenting at least one Trigger Association Item to Uploading Users;
(b) receiving Association Chains from at least a portion of said Uploading Users in response to said presented at least one Trigger Association Item, each said Association Chain including at least one Association Item; and
(c) storing said Association Chains in an Association Database.

20. The method of claim 19, further comprising the steps of:
(d) providing an End User Interface (EUI), for interfacing between said Association Database and an End User.

21. The method of claim 19, wherein said storing includes a recognition process including steps of:
(i) checking each unique said Association Item, in said Association Chains, for lingual proximity to a stored said Association Item;
(ii) correcting each said unique Association Item having said lingual proximity to a said stored Association Item; and
(iii) counting instances of each said Association Item.

22. The method of claim 19, further comprising the steps of:
(d) receiving a search query at said Association Database; and
(e) presenting search results selected from said Association Database, said search results including at least one said Association Chain being responsive to said search query.

23. The method of claim 22, further comprising:
(f) learning patterns in which said search queries are received and in which said search result are selected so as to provide enhanced searching features.

24. The method of claim 19, further comprising the steps of:
(d) collecting user information regarding said Uploading Users.

25. The method of claim 24, further comprising the steps of:
(e) receiving a report request for said user information; and
(f) presenting report responsive to said report request.

26. The method of claim 19, wherein said Trigger Association Item includes a said Association Item selected from said Association Database.
